(19) United States
(12) Patent Application Publication
(10) Pub. No.: US 2025/0205531 A1
(43) Pub. Date: Jun. 26, 2025

(54) FIRE-RETARDANT FOAM CONCENTRATES

(71) Applicant: Kinetic Foam Engineering International, LLC, Midland, MI (US)

(72) Inventors: Akin Ozkutan, Voorburg (NL); John C. Tolfa, Midland, MI (US); Robert D. Mussell, Midland, MI (US)

(73) Assignee: Kinetic Foam Engineering International, LLC, Midland, MI (US)

(21) Appl. No.: 18/846,456

(22) PCT Filed: Mar. 14, 2023
(86) PCT No.: PCT/US2023/015220

§ 371 Date: Sep. 12, 2024

Related U.S. Application Data
(60) Provisional application No. 63/320,086, filed on Mar. 15, 2022.

(51) Int. Cl. A62D 1/02

(52) U.S. Cl. CPC A62D 1/0071

(57) ABSTRACT

A foam forming concentrate is provided. The foam forming concentrate includes a surfactant component. The surfactant component includes an anionic surfactant and an amphoteric surfactant. The foam forming concentrate further includes a solvent component including a polar alkyl ether. The foam forming concentrate further includes a gelling component selected from the group of a carbohydrate, a synthetic hydrocolloid, or a combination thereof. The gelling component is substantially insoluble in the solvent component. The foam forming concentrate has a viscosity of no greater than 2,000 centipoise. The foam forming concentrate at a concentration of at least 1% (w/w) in water is capable of extinguishing a fire fueled by heptane within a time period of less than 5 minutes at a flow rate of 3 gallons per minute as determined in accordance with UL 162.

### RELATED APPLICATIONS

This application claims priority to our copending provisional application with the Ser. No. 63/320,086, which was filed Mar. 15, 2022, and which is incorporated by reference herein.

### TECHNICAL FIELD

The field of the invention is compositions and methods for fire-retardant foam concentrates and the use of the same to extinguish fires.

### BACKGROUND

The background description includes information that may be useful in understanding the present invention. It is not an admission that any of the information provided herein is prior art or relevant to the presently claimed invention, or that any publication specifically or implicitly referenced is prior art.

All publications and patent applications herein are incorporated by reference to the same extent as if each individual publication or patent application were specifically and individually indicated to be incorporated by reference. Where a definition or use of a term in an incorporated reference is inconsistent or contrary to the definition of that term provided herein, the definition of that term provided herein applies and the definition of that term in the reference does not apply.

Firefighting foam concentrates are mixtures of foaming agents, solvents, and other additives. These concentrates are intended to be mixed with water at a concentration of from 0.1% to 6%, depending on the class of the foam (e.g., Class A may be from 0.1% to 1% or even more and Class B may be from 3% to 6% or even more) and then projected onto the surface of a burning liquid (e.g., heptane).

The foam can be dispersed onto a liquid chemical fire to form a thick foam blanket that knocks down the fire and then extinguishes the fire by suffocation. These foams also find utility as vapor suppressing foams that can be applied to non-burning but volatile liquids, e.g., volatile liquid or solid chemicals and chemical spills, to prevent evolution of toxic, noxious, flammable, or otherwise dangerous vapors. These foams can also be used on structural and bush or forest fires.

Individual components of a foaming concentrates contribute toward different physical and chemical properties of the premix and the foam. Selective surfactants can provide low surface tension, high foamability, and good film stability. Organic solvents can be included to promote solubility of surfactants, to promote shelf life of the concentrate, and to stabilize the aqueous foam. Thickening agents can be used to increase viscosity and stability of the foam. Other agents and additives can be used as is known to those skilled in the art.

A particular class of firefighting foam concentrates is known as an aqueous film-forming foam (AFFF or AF³) AFFF concentrates have the quality of being able to spread an aqueous film on the surface of hydrocarbon liquids, enhancing the speed of extinguishment. This is made possible by organo-fluorinated surfactants, such as perfluoroalkyl surfactants (PFAS) contained in the AFFF. While these surfactants produce very low surface tension values in solution (15-20 dynes cm⁻¹) which permit the foam to spread on the surface of the hydrocarbon liquids, various regulatory bodies recommend against, or prohibit the use of, foams that intentionally include fluorinated surfactants. In an effort to avoid these restrictions, namely restrictions related to PFAS, some manufactures purposely manufacture their “PFAS-free” foams using the same equipment as their PFAS-containing foams to allow their “PFAS-free” foams to benefit from the inclusion of any residual PFAS remaining on the equipment while believing that they are not intentionally including PFAS. To this end, these manufactures continue to market their foams that include the residual PFAS as “PFAS-free.”

The aforementioned foams fail to exhibit the low viscosities necessary for use in conventional fire suppression equipment or fail to extinguish fires at the desired rate. Importantly, in an effort to avoid the intentional use of fluorinated and chlorinated compounds, conventional foams can include gums. However, the amount of gum necessary to effectively extinguish fires results in an increase in viscosity that renders the foam composition incompatible with conventional fire suppression equipment. Consequently, while the inclusion of gums enable formation of an aqueous film-forming foam, such benefit is opposed by an increase in viscosity that renders formulations unsuitable for use. Moreover, the stability of PFAS free concentrates that contain gums is in at least some cases problematic.

Thus, even though various compositions for fire extinguishment are known in the art, all or almost all of them suffer from several drawbacks. Therefore, there remains a need for improved foam forming compositions and methods for the same.

### BRIEF SUMMARY

The inventive subject matter is directed to various foam forming concentrates, foam solutions, and foams including, or formed from, the same. The foam forming concentrate is capable of forming foam solutions and foams to extinguish fires. In particular, the foam forming concentrates and resulting foam solutions exhibit reduced viscosities while still quickly extinguishing fires, respectively. Moreover, the foam formed from the foam forming concentrate can form a continuous layer that is capable of reforming after a disruption has been made in the continuous layer (i.e., the foam is capable of self-healing). Still further, the foam forming concentrate exhibit desirable storage characteristics (e.g., lack phase separation) and superior miscibility with water to form a foam.

In various embodiments, the foam forming concentrates are suitable for use with conventional fire suppression equipment and thus may be characterized as “drop-in” foam forming concentrates at least due to their reduced viscosity prior to dilution with water which allows for its dilution to be performed using conventional mixtures that are part of the conventional fire suppression equipment. The foam forming concentrate may also be referred to as a foam forming composition. Contemplated concentrates can be tuned to have a low, medium, or high rate of expansion, depending on application, equipment, and technique. For example, the foam forming concentrates as contemplated herein typically have a reduced foam expansion (e.g., no greater than 6) as compared to conventional foam concentrates that include fluorinated surfactants. It is believed that the reduced foam expansion (1) reduces the impact of wind on the foam during application of the foam solution and thus improves delivery of the foam solution from the applicator to the target and (2) improves the capability of a continuous foam layer to reform after a disruption has been made in the continuous layer (i.e., improves self-healing of the foam).

In one aspect of the inventive subject matter, the inventors contemplate that the foam forming concentrate includes a surfactant component, a gelling component, and a solvent component. The gelling component is selected from the group of a carbohydrate (e.g., monosaccharides, disaccharides, polysaccharides, etc.), a synthetic hydrocolloid, or combinations thereof. The foam forming concentrate has a viscosity of no greater than 2,000 centipoise (e.g., no greater than 800 centipoise). The foam forming concentrate at a concentration of at least 1% (w/w) in water (e.g., fresh water, salt water, brackish water, etc.) is capable of extinguishing a fire fueled by heptane within a time period of less than 5 minutes at a flow rate of 3 gallons per minute as determined in accordance with UL 162.

It is contemplated that the surfactant component includes an anionic surfactant and an amphoteric surfactant. In various embodiments, the surfactant component further includes a nonionic surfactant. The surfactant is present in an amount of at least 5 (e.g., 7, 8, or 10) wt. % based on a total weight of the foam forming concentrate.

In certain embodiments, the anionic surfactant is selected from the group of an ammonium alkyl sulfate, a sodium alkyl sulfate, alkyl diphenyloxide disulfonate, a carboxylic acid surfactant, dioctyl sulfosuccinate, or combinations thereof. In these and other embodiments, the anionic surfactant incudes the ammonium alkyl sulfate (e.g., ammonium lauryl sulfate) and the sodium alkyl sulfate (e.g., sodium lauryl sulfate).

In various embodiments, the amphoteric surfactant is selected from the group of a betaine, alkyl hydroxysultaine, alkyl amine oxide, alkyl aminopropionic acid, or combinations thereof. In these and other embodiments, the amphoteric surfactant includes the betaine, such as an alkyl amido betaine (e.g., cocoamidopropyl betaine).

In some embodiments, the nonionic surfactant is selected from the group of an alkyl polyglucoside, a silicon-based surfactant, a branched secondary alcohol ethoxylates, alkoxylated polyol, a block copolymers of two or more of polyoxyethylene, polyoxypropylene, and polyoxybutylene, or a combination thereof. In these and other embodiments, the nonionic surfactant includes the alkyl polyglucoside.

Referring now to the gelling component, it is contemplated that the gelling component is substantially insoluble in the solvent component (e.g., as determined in accordance with ASTM D3132-84). The carbohydrate may include a polysaccharide (e.g., modified starch). The gelling component is present in an amount of at least 0.1 wt. % based on a total weight of the foam forming concentrate.

Referring now to the solvent component, it is contemplated that that the solvent component includes a polar alkyl ether. In certain embodiments, the polar alkyl ether is selected from the group of diethylene glycol monobutyl ether, ethylene glycol mono-n-butyl ether, ethylene glycol mono-n-propyl ether, triethylene glycol ethyl ether, triethylene glycol mono n-butyl ether, tripropylene glycol methyl ether, propylene glycol mono n-propyl ether, or combinations thereof. In these and other embodiments, the polar alkyl ether includes diethylene glycol monobutyl ether and ethylene glycol mono-n-butyl ether. It is contemplated herein that the gelling component and the polar alkyl ether may cooperate to provide partial hydration of the gelling component during formation of the foam forming concentrate to control viscosity and stability of the foam forming concentrate. Without being bound by theory, it is believed that the high organic solvent to water ratio of the foam forming concentrate provides a solvent-rich concentrate suitable for managing free water content thereby limiting hydration of the gelling component to only partial hydration. Dilution of the foam foaming concentrate with an abundance of free water allows full hydration of the gelling component inclusive to form the foam solution. It is contemplated that an increase in free water concentration (e.g., after combination with water prior to application) provides substantially full hydration of the gelling component. Substantially full hydration of the gelling component provides improved foam formation, extend drain time, self-healing, and fire extinguishment.

In various embodiment, the solvent component further includes an alkylene glycol, water, or a combination thereof. In these and other embodiments, the solvent component further includes the alkylene glycol and water. The alkylene glycol may include propylene glycol.

In another aspect of the invention, the inventors contemplate that the foam solution includes, or is formed from, the foam forming concentrate and water (e.g., fresh water, salt water, brackish water, etc.). The foam is formed from the foam solution upon application to the target. The foam may extend in a continuous layer. When a disruption in the continuous layer is formed by an external force that is applied to the continuous layer, the foam is capable of reforming the continuous layer. The foam solution including the foam forming concentrate in amount of at least 1 wt. % based on a total weight of the foam is capable of extinguishing a fire fueled by heptane within a time period of less than 5 minutes as determined in accordance with UL 162.

Various objects, features, aspects and advantages of the inventive subject matter will become more apparent from the following detailed description of preferred embodiments.

### DETAILED DESCRIPTION

The inventors have discovered various foam forming concentrates, foam solutions, and foams formed from the same. The foam forming concentrate may also be referred to as a foam forming composition. The foam forming concentrate is capable of forming foams to extinguish fires. In particular, the foam forming concentrate exhibits a reduced viscosity, while the resulting foam is capable of quickly extinguishing fires. The foam forming concentrate has a viscosity of no greater than 2,000 no greater than 1,000 centipoise, no greater than 900 centipoise, no greater than 800 centipoise, no greater than 700 centipoise, no greater than 600 centipoise, no greater than 500 centipoise, or even lower. This reduced viscosity provides improved compatibility with existing fire extinguishing equipment and systems, such as those designed for use with conventional fluorinated foam concentrates. Such low viscosity is particularly notable as the compositions presented herein include polysaccharides/gums as gelling agent but do not include PFAS surfactants as a functional ingredient. Fluorosurfactant foams typically drain fast and rely on the film formed at the foam/fuel interface by the PFAS, fluorosurfactant or fluorinated polymer to provide a vapor barrier and enhance extinguishment times. Fluorine free foams rely on slow draining foams that retrain water longer to provide a vapor barrier and extend burnback. Polymer thickeners, hydrocolloids, and other carbohydrates drain slower and create a polymer rich barrier near the fuel surface to act as a vapor barrier over the combustible fuel surface.

With regard to being capable of quickly extinguishing fires, the foam forming concentrate at a concentration of at least 1% (w/w) (e.g., 3%, 6% or even more) in water (e.g., fresh water, salt water, brackish water, etc.) to form the foam solution is capable of extinguishing a fire fueled by heptane within a time period of less than 5 minutes (e.g., less than 4.5, less than 4, less than 3.5, less than 3, less than 2.5, less than 2, less than 1.5, or less than 1 minute(s)) as determined in accordance with UL 162 (Class B). Moreover, the foam formed from, or including, the foam forming concentrate can form a continuous layer that is capable of reforming after a disruption has been made in the continuous layer (i.e., the foam is capable of self-healing), which in turn results in improved extinguishment of fires.

Furthermore, the foam forming concentrate diluted to a concentration of at least 0.1% (w/w) (e.g., 0.5%, 1% or even more) in water (e.g., fresh water, salt water, brackish water, etc.) to form the foam solution is capable of extinguishing a fire fueled by heptane within a time period of less than 1 minutes (e.g., less than 55, less than 50, less than 45, less than 40, less than 35, less than 30, less than 25, or less than 20 seconds) as determined in accordance with UL 162).

In exemplary embodiments, the inventors contemplate that the foam forming concentrate includes a surfactant component, a gelling component selected from the group of a carbohydrate (e.g., one or more starches and/or gums), a synthetic hydrocolloid, or a combination thereof, and a solvent component. The term “component” as utilized herein with regard to a surfactant, a gelling material, and a solvent is merely used as placeholder to ease understanding of the composition and its ingredients, along with ingredient amounts and ratios, such that the surfactant component may include, consists essentially of, consist of or be, one or more surfactants; the gelling component may include, consists essentially or, consist of or be, one or more gelling materials; and the solvent component may include, consists essentially of, consist of or be, one or more solvents. To this end, any ingredient that is referenced herein as being included in a component is also included in the foam forming concentrate. The foam forming concentrate may include a variety of other components or ingredients as will be described in greater detail below so long as the components or ingredients are compatible with the composition.

It is contemplated that the surfactant component includes an anionic surfactant and an amphoteric surfactant. The anionic surfactant and the amphoteric surfactant may be present in a weight ratio of from 10:1 to 1:10, from 5:1 to 1:1, or from 3:1 to 2:1. In various embodiments, the surfactant component further includes a nonionic surfactant. The anionic surfactant and the nonionic surfactant may be present in a weight ratio of from 10:1 to 1:10, from 3:1 to 1:3, or from 2:1 to 1:1. However, it is to be appreciated that the surfactant component may include any other surfactant, such as a cationic surfactant. The surfactant component is present in an amount of at least 1 wt. %, at least 2 wt. %, at least 3 wt. %, at least 4 wt. %, at least 5 wt. %, at least 10 wt. %, or even more based on a total weight of the foam forming concentrate.

The anionic surfactant may be any anionic surfactant known in the art so long as it is compatible with the foam forming concentrate. Suitable anionic surfactants may include, but are not limited to, methyl ester sulfonate, a hydrolyzed keratin, polyoxyethylene sorbitan monopalmitate, polyoxyethylene sorbitan monostearate, polyoxyethylene sorbitan monooleate, an alkyl ether sulfate, sodium 4-(1′heptylnonyl)benzenesulfonate, sodium dioctyl sulphosuccinate, sodium octlylbenzenesulfonate, an ammonium alkyl sulfate (e.g., ammonium lauryl sulfate and the like), a sodium alkyl sulfate (e.g., sodium decyl sulfate, sodium lauryl sulfate, sodium hexadecyl sulfate, and the like), sodium laureth sulfate, an alkyl ester sulfonate, an alkyl ether sulfonate, an alkyl ether sulfate, an alkali metal alkyl sulfate, an alkyl sulfonate, an alkylaryl sulfonate, a sulfosuccinate, an alkyl disulfonate, an alkylaryl disulfonate, an alkyl disulfate, an alcohol polypropoxylated sulfate, an alcohol polyethoxylated sulfate, a carboxylic acid surfactant, any derivative thereof, or any combination thereof. As used herein, the term “derivative,” refers to any compound that is made from one of the identified compounds, for example, by replacing one atom in the listed compound with another atom or group of atoms or rearranging two or more atoms in the listed compound.

In certain embodiments, the anionic surfactant is selected from the group of an ammonium alkyl sulfate, a sodium alkyl sulfate, alkyl diphenyloxide disulfonate, a carboxylic acid surfactant, dioctyl sulfosuccinate, or combinations thereof. In some embodiments, the anionic surfactant incudes the ammonium alkyl sulfate (e.g., ammonium lauryl sulfate) and the sodium alkyl sulfate (e.g., sodium lauryl sulfate). In other embodiments, the anionic surfactant includes the carboxylic acid surfactant.

As used herein, the phrase “carboxylic acid surfactant” refers to a surfactant including a carboxylic acid moiety and/or a carboxylate moiety. Generally, carboxylic acids have the formula R—COOH wherein the R can represent any number of different groups including alkyl, arylalkyl, cycloalkyl, aromatic, or heterocyclic groups, all of which can be saturated or unsaturated as well as substituted or unsubstituted. Carboxylic acids can have one, two, three, or more carboxyl groups. Suitable carboxylic acids include carboxylic acid surfactants. In some embodiments, suitable carboxylic acid surfactants include those categorized as an anionic surfactant. In other embodiments, suitable carboxylic acid surfactants include those categorized as an amphoteric surfactant. The carboxylic acid surfactant may contain, for example, at least one alkyl amine moiety, at least one alkyl carboxylate moiety, at least one alkyl amide moiety, at least one sulfonate moiety, and/or at least one alkoxylate moiety.

Non-limiting examples of suitable carboxylic acid surfactants include those described by Formula I:

(R₁)(R₂)X(R₃COOH) (I)

In certain embodiments, in Formula I, R₁ and R₂ can independently be absent, alkyl moiety, alkyl carboxylate moiety, alkyl amide moiety, alkyl sulfonate moiety, or alkoxylate moiety; X can be N, NH, C═O, or CH₂; and R₃ can be alkyl or alkyl sulfonate moiety.

Non-limiting examples of suitable carboxylic acid surfactants further include those described by Formula II:

(R₁)(R₂)N(R₃COOH) (II)

In Formula II, for example, R₁ and R₂ can independently be alkyl moiety, alkyl carboxylate moiety, alkyl amide moiety, alkyl sulfonate moiety, or alkoxylate moiety and R₃ can be alkyl or alkyl sulfonate moiety.

Non-limiting examples of suitable carboxylic acid surfactants further include those described by Formula (III):

(R₁)C(O)(R₃COOH) (III)

In Formula (III), for example, R₁ can be alkoxylate moiety and R₃ can be alkyl or alkyl sulfonate moiety.

Non-limiting examples of suitable carboxylic acid surfactants further include those described by Formula (IV):

(R₁)CH₂(R₃COOOH) (IV)

In Formula (IV), for example, R₁ can be alkoxylate moiety and R₃ can be absent, alkyl, or alkyl sulfonate moiety.

Non-limiting examples of suitable carboxylic acid surfactants further include those described by Formula (V):

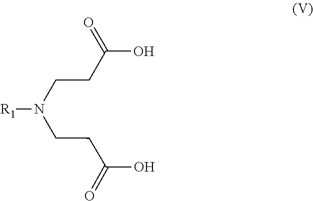

In Formula (V), R₁ can be C₈H₁₇ and the nitrogen can be protonated or unprotonated.

Non-limiting examples of suitable carboxylic acid surfactants further include those described by Formula (VI):

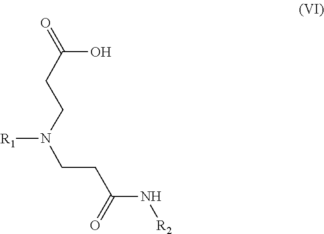

In Formula (VI), R₁ and R₂ can be C₈H₁₇ and the nitrogen can be protonated or unprotonated.

Non-limiting examples of suitable carboxylic acid surfactants further include those described by Formula (VII):

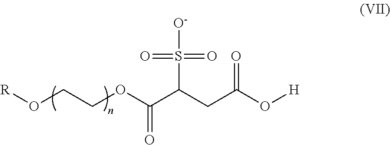

In Formula (VII), R can be C₁₁H₂₃; n can be 1-12 (e.g., 3); and the sulfonate can be in the form of a sodium salt.

Non-limiting examples of suitable carboxylic acid surfactants further include those described by Formula (VIII):

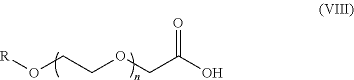

In Formula (VIII), R can be C₁₂H₂₅, C₁₃H₂₇, or a mixture thereof; and n can be 1-12 (e.g., 3).

The anionic surfactant may be present in any amount suitable for foam forming concentrates. The anionic surfactant may be present in an amount of at least 1 wt. %, at least 10 wt. %, at least 20 wt. %, at least 30 wt. %, or at least 40 wt. % based on a total weight of the surfactant component. The anionic surfactant may be present in an amount of no greater than 99 wt. %, no greater than 80 wt. %, no greater than 70 wt. %, no greater than 60 wt. %, or no greater than 50 wt. % based on a total weight of the surfactant component. The anionic surfactant may be present in an amount of from 1 to 99 wt. %, from 10 to 80 wt. %, from 20 to 70 wt. %, from 30 to 60 wt. %, or from 40 to 50 wt. % based on a total weight of the surfactant component. The anionic surfactant may be present in an amount of from 0.01 to 10 wt. %, from 0.05 to 9 wt. %, from 0.1 to 8 wt. %, from 0.5 to 7 wt. %, or from 0.5 to 6 wt. % based on a total weight of the foam forming concentrate.

The amphoteric surfactant may be any amphoteric surfactant known in the art so long as it is compatible with the foam forming concentrate. Suitable amphoteric surfactants may include, but are not limited to, an alkyl amine oxide, a betaine (e.g., a modified betaine, an alkyl betaine, an alkylamidobetaine, an alkyl amidopropyl betaine, or an alkyl sulfobetaine), an alkyl hydroxysultaine, a dihydroxyl alkyl glycinate, an alkyl ampho acetate, a phospholipid, amino propionic acids, imido propionic acids, quaternized compounds, an alkyl aminopropionic acid, an alkyl imino monopropionic acid, an alkyl imino dipropionic acid, dipalmitoyl-phosphatidylcholine, an amine oxide, any derivative thereof, or any combination thereof. As used herein, the term “derivative,” refers to any compound that is made from one of the identified compounds, for example, by replacing one atom in the listed compound with another atom or group of atoms or rearranging two or more atoms in the listed compound.

In various embodiments, the amphoteric surfactant is selected from the group of a betaine, alkyl hydroxysultaine, alkyl amine oxide, alkyl aminopropionic acid, or combinations thereof. In these and other embodiments, the amphoteric surfactant includes the betaine, such as alkyl amido betaine (e.g., cocoamidopropyl betaine).

The amphoteric surfactant may be present in any amount suitable for foam forming concentrates. The amphoteric surfactant may be present in an amount of at least 1 wt. %, at least 10 wt. %, at least 20 wt. %, at least 25 wt. %, or at least 30 wt. % based on a total weight of the surfactant component. The amphoteric surfactant may be present in an amount of no greater than 99 wt. %, no greater than 75 wt. %, no greater than 65 wt. %, no greater than 55 wt. %, or no greater than 45 wt. % based on a total weight of the surfactant component. The amphoteric surfactant may be present in an amount of from 1 to 99 wt. %, from 10 to 75 wt. %, from 20 to 65 wt. %, from 25 to 55 wt. %, or from 30 to 45 wt. % based on a total weight of the surfactant component. The amphoteric surfactant may be present in an amount of from 0.01 to 10 wt. %, from 0.05 to 9 wt. %, from 0.1 to 8 wt. %, from 0.5 to 7 wt. %, or from 0.5 to 6 wt. % based on a total weight of the foam forming concentrate.

The nonionic surfactant may be any nonionic surfactant known in the art so long as it is compatible with the foam forming concentrate. Suitable nonionic surfactants may include, but are not limited to, an alkyoxylate (e.g., an alkoxylated nonylphenol condensate, such as poly(oxy-1,2-ethanediyl), alpha-(4-nonylphenyl)-omega-hydroxy-branched), an alkylphenol, an ethoxylated alkyl amine, an ethoxylated oleate, a tall oil, an ethoxylated fatty acid, an alkyl glucoside, a polyglucoside, an alkyl polyglucoside, a sorbitan ester, a methyl glucoside ester, an amine ethoxylate, a diamine ethoxylate, a polyglycerol ester, an alkyl ethoxylate, an alcohol that has been polypropoxylated and/or polyethoxylated, a linear alcohol alkoxylate, branched secondary alcohol ethoxylate, a linear nonyl-phenol ethoxylate, dioxane, ethylene oxide, polyethylene glycol, an ethoxylated castor oil, polyoxyethylene nonyl phenyl ether, tetraethyleneglycoldodecylether, ethylene oxide, decylamine oxide, dodecylamine oxide, an alkylamine oxide, an ethoxylated amide, an alkoxylated fatty acid, an alkoxylated alcohol (e.g., lauryl alcohol ethoxylate, ethoxylated nonyl phenol), an alkoxylated polyol (e.g., an ethoxylated polyol, a propoxylated polyol, and a butoxylated polyol), block copolymers of two or more of polyoxyethylene, polyoxypropylene, and polyoxybutylene, an ethoxylated fatty amine, an ethoxylated alkyl amine (e.g., cocoalkylamine ethoxylate), any derivative thereof, or any combination thereof. As used herein, the term “derivative,” refers to any compound that is made from one of the identified compounds, for example, by replacing one atom in the listed compound with another atom or group of atoms or rearranging two or more atoms in the listed compound.

Other non-limiting examples of suitable nonionic surfactants include ethoxylated linear alcohols, ethoxylated alkyl phenols, fatty acid esters, amine and amide derivatives, alkylpolyglucosides, ethleneoxide/propyleneoxide copolymers, polyalcolols and ethoxylated polyalcohols, thiols (mercaptans) and derivates, ethoxylated thiols, amide-, ester- and ether-amines, oxy- and ethoxy-amines, alkanol-amides, amino-acids, amines, fatty amines, quaternary alkyl-ammoniums (quats), or combinations thereof. Specific examples includes, but are not limited to, sorbitan trioleate, sorbitan tristearate, propylene glycol monostearate, glycerol monostearate, sorbitan monooleate, sorbitan monostearate, diethylene glycol monolaurate, sorbitan monolaurate, glycerol monostearate, polyoxyethylene(2) cetyl ether, polyoxyethylene(10) cetyl ether, polyoxyethylene(2) cetyl ether, polyoxyethylene(6) tridecyl ether, polyoxyethylene(12) tridecyl ether renex, polyoxyethylene(15) tridecyl ether, or combinations thereof.

In some embodiments, the nonionic surfactant is selected from the group of an alkyl polyglucoside, a silicon-based surfactant, a branched secondary alcohol ethoxylates, alkoxylated polyol, a block copolymer of two or more of polyoxyethylene, polyoxypropylene, and polyoxybutylene, or a combination thereof. In these and other embodiments, the nonionic surfactant includes the alkyl polyglucoside. Non-limiting examples of suitable alkyl glucosides, polyglucosides, and alkyl polyglucoside are described in, for example, in U.S. Pat. No. 5,207,932, the disclosure of which is incorporated herein by reference in its entirety. Therefore, suitable nonionic surfactants include modified (e.g., alkylated) carbohydrates, and especially modified starches, that may be partially hydrolyzed (e.g., to have dextrose equivalents between 2-5, or between 5-8, or between 7-12, or between 10-15, or between 12-20, or between 17-25). Furthermore, it should be appreciated that the modifications to the carbohydrates will provide a degree of hydrophobicity to the carbohydrate such as to enable a surfactant function. As such, the modification will include an addition of alkyl groups having chain lengths of between 2-6 carbon atoms, 4-8 carbon atoms, 6-10 carbon atoms, 8-12 carbon atoms, and even longer. In still further embodiments, and particularly where the carbohydrate is a starch it is generally preferred that the starch particles will comprise linear and branched carbohydrates chains (e.g., having at least 15%, or at least 20%, or at least 25% branched chains), and/or that the particles will have a relatively small average particle size (e.g., between 10-25 micron, or between, 20-40 micron, or between 25-60 micron, or between 50-100 micron).

Non-limiting example of suitable silicone-based surfactants include a glycerin-modified silicone, a sugar-modified silicone, a sugar alcohol-modified silicone, a carboxylic acid-modified silicone, a polyglycerin-modified silicone elastomer (e.g., a polyglycerated silicone elastomer), an organopolyoxyalkylene group-containing silicone-based surfactant, a silicone-based nonionic surfactant in which an alkyl branch, a straight chain silicone branch, a siloxane dendrimer branch or the like is provided along with a hydrophilic group, a polyoxyalkylene-modified silicone (e.g., a polyether-modified silicone), a polyether-modified silicone elastomer (e.g., polyoxyalkylated silicone elastomer), or combinations thereof. It is to be appreciated that the silicone-based surfactant may be utilized to provide vapor suppression of polar fuels to the foam formed from the foam forming concentrate.

The nonionic surfactant may be present in any amount suitable for foam forming concentrates. The nonionic surfactant may be present in an amount of at least 1 wt. %, at least 5 wt. %, at least 10 wt. %, at least 12.5 wt. %, or at least 15 wt. % based on a total weight of the surfactant component. The nonionic surfactant may be present in an amount of no greater than 99 wt. %, no greater than 60 wt. %, no greater than 50 wt. %, no greater than 40 wt. %, or no greater than 30 wt. % based on a total weight of the surfactant component. The nonionic surfactant may be present in an amount of from 1 to 99 wt. %, from 5 to 60 wt. %, from 10 to 50 wt. %, from 12.5 to 40 wt. %, or from 15 to 30 wt. % based on a total weight of the surfactant component. The nonionic surfactant may be present in an amount of from 0.01 to 10 wt. %, from 0.05 to 9 wt. %, from 0.1 to 8 wt. %, from 0.5 to 7 wt. %, or from 0.5 to 6 wt. % based on a total weight of the foam forming concentrate.

Referring now to the gelling component, it is contemplated that the gelling component is substantially insoluble in the solvent component (e.g., as determined in accordance with ASTM D3132-84). However, it is to be appreciated that other test methods for solubility may be utilized. The term “substantially” as utilized herein with regard to solubility of the gelling component means that less than 10 wt. %, less than 5 wt. %, less than 1 wt. %, less than 0.5 wt. %, less than 0.1 wt. %, or less than 0.01 wt. % of the gelling component solubilizes in the water of the foam forming concentrate. Without being bound by theory, it is believed that the gelling component provides improved vapor suppression to the foam formed from the foam forming composition. This improved vapor suppression reduces the occurrence of burn-back after a fire has been initially extinguished. In practice, this allows the user of the foam forming concentrate to move on to other fires knowing that the occurrence of burn-back is reduced and any disruptions that may occur to the continuous form layer may be self-healed thereby maintaining the vapor suppression. In various embodiments, the foam formed form the foam forming composition provides improved vapor suppression as compared to a conventional foam free of the gelling component as determined in accordance with UL162. The gelling component is present in an amount of at least 0.1 wt. %, at least 0.5 wt. %, at least 1 wt. %, at least 1.5 wt. %, or at least 2 wt. % based on a total weight of the foam forming concentrate.

In various embodiments, the gelling component includes a hydrocolloid (e.g., a hydrocolloid carbohydrate or a synthetic hydrocolloid). As contemplated herein, the hydrocolloid absorbs water to the extent that it is water swellable. In general, hydrocolloids are hydrophilic polymers derived from a number of different sources including plant (e.g., locust bean gum, carrageenan, pectin, starch), animal (e.g., chitosan), microbial (e.g., xanthan gum), or chemical modification of natural carbohydrates (e.g., carboxymethyl cellulose). Synthetic hydrocolloids may include hydrolyzed polyacrylamide (HPAM), poly acrylic acid, polyethylene oxide (PEO), or combinations thereof. Hydrocolloids may be incorporated into the foam forming concentrate to control rheology and structure of the resulting foam. In aqueous environments, hydrocolloids swell, increasing their hydrodynamic volume, thereby increasing the viscosity of the foam forming concentrate or the resulting foam solution. Therefore, it was surprising to the inventors to discover that foam forming concentrates could be prepared that had desirably low viscosity, while still rendering the resulting foam capable of quickly extinguishing fires. To this end, an important aspect of the hydrocolloid (and other gelling agents) is its capability to absorb water at the time of use (i.e. be swellable in the presence of water) yet remain substantially insoluble in water in the concentrate form for providing rheology control and structure to the resulting foam. In particular, it is believed that the hydrocolloid may be added to the foam forming concentrate to improve foam stability by decreasing drainage, or to improve burn-back performance of the foam. The hydrocolloid may be present in an amount of at least 10 wt. %, at least 20 wt. %, at least 30 wt. %, at least 40 wt. %, or at least 50 wt. % based on a total weight of the gelling component. The hydrocolloid may be present in an amount of at least 0.1 wt. % at least 0.5 wt. %, at least 1 wt. %, at least 1.5 wt. %, or at least 2 wt. % based on a total weight of the foam forming concentrate.

Without being bound by theory, it is believed that the hydrocolloid provides water retention properties that result in improved foams without the use of, or with only limited amounts of fluorinated surfactants. In various embodiments, the foam forming concentrate is substantially free of fluorinated surfactants. The term “substantially” as utilized herein with regard to fluorinated surfactants means that foam forming concentrate includes less than 1 wt. %, less than 0.5 wt. %, less than 0.1 wt. %, less than 0.01 wt. %, less than 0.001 wt. %, or less than 0.0001 wt. % of the fluorinated surfactants. In these and other embodiments, the method of forming the foam forming concentrate does not utilize equipment that is utilized to form any compositions comprising fluorinated surfactants. However, it is to be appreciated that the foam forming concentrate could be utilized with equipment that includes residual fluorinated surfactants and the foam forming concentrate may unintentionally benefit from such residual fluorinated surfactants.

The gelling component may include a carbohydrate, such as a polysaccharide, a modified polysaccharide, or a combination thereof. The polysaccharide or modified polysaccharide may be the hydrocolloid. In various embodiments, the polysaccharide is selected from the group of a modified starch, agar, sodium alginate, carrageenan, gum guaicum, neem gum, Pistacia lentiscus, gum chatti, caranna, galactomannan, gum tragacanth, karaya gum, guar gum, welan gum, rhamsam gum, locust bean gum, beta-glucan, cellulose, methylcellulose, chicle gum, kino gum, dammar gum, gum arabic, glucomannan, mastic gum, spruce gum, tara gum, pysllium seed husks, gellan gum, xanthan gum, acacia gum, cassia gum, diutan gum, fenugreek gum, ghatti gum, hydroxyethylcellulose, hydroxypropylmethylcellulose, karaya gum, konjac gum, pectin, propylene glycol alginate, or combinations thereof. The modified polysaccharide may be any of the polysaccharide described above that undergo etherification, esterification, amidation, carboxymethylation, oxidation condensation with carbonyl compounds, synthesis of grafted or block copolymers, or combinations thereof, and the like as described in Desbrieres J. et al., 10—Chemically Modified Polysaccharides With Applications in Nanomedicine, Biomass as Renewable Raw Material to Obtain Bioproducts of High-Tech Value, 2018, Pages 351-399, the disclosure of which is incorporated herein by reference in its entirety. In various embodiments, the modified polysaccharide may exhibit properties similar to a surfactant. The carbohydrate may be present in an amount of at least 0.1 wt. % at least 0.5 wt. %, at least 1 wt. %, at least 1.5 wt. %, or at least 2 wt. % based on a total weight of the foam forming concentrate.

In various embodiments, the modified starch is selected from the group of hydroxypropyl starch, starch acetates, monostarch phosphate, distarch phosphate, alkyl (e.g., C₄, C₆, C₈, C₁₀, C₁₂, C₁₄) succinated starch, distarch adipate, hydroxypropylated distarch phosphate, phosphorylated distarch phosphate, acetylated distarch phosphate, acetylated distarch adipate, or combinations thereof. The modified starch may be present in an amount of at least 10 wt. %, at least 20 wt. %, at least 30 wt. %, at least 40 wt. %, or at least 50 wt. % based on a total weight of the carbohydrate. The modified starch may be present in an amount of at least 0.1 wt. % at least 0.5 wt. %, at least 1 wt. %, at least 1.5 wt. %, or at least 2 wt. % based on a total weight of the foam forming concentrate.

In certain embodiments, the polysaccharide includes the modified starch. In these and other embodiments, the gelling component includes the modified starch and at least one additional polysaccharide. In some embodiments, the gelling component includes the polysaccharide and at least one additional polysaccharide The at least one additional polysaccharide is selected from the group of agar, sodium alginate, carrageenan, gum guaicum, neem gum, Pistacia lentiscus, gum chatti, caranna, galactomannan, gum tragacanth, karaya gum, guar gum, welan gum, gum arabic, rhamsam gum, locust bean gum, beta-glucan, cellulose, methylcellulose, chicle gum, kino gum, dammar gum, glucomannan, mastic gum, spruce gum, tara gum, pysllium seed husks, gellan gum, xanthan gum, acacia gum, cassia gum, diutan gum, fenugreek gum, ghatti gum, hydroxyethylcellulose, hydroxypropylmethylcellulose, karaya gum, konjac gum, pectin, propylene glycol alginate, or combinations thereof. Without being bound by theory, it is believed that the modified starch and the at least one additional polysaccharide act synergistically to impart improved foam stability. The additional polysaccharide may be present in an amount of at least 10 wt. %, at least 20 wt. %, at least 30 wt. %, at least 40 wt. %, or at least 50 wt. % based on a total weight of the gelling component. The additional polysaccharide may be present in an amount of at least 0.1 wt. %, at least 0.5 wt. %, at least 1 wt. %, at least 1.5 wt. %, or at least 2 wt. % based on a total weight of the foam forming concentrate.

Referring now the solvent component, it is contemplated that that the solvent component includes an organic solvent, water, or a combination thereof. Organic solvents can be included in the foam foaming concentrate to reduce viscosity of the concentrate (e.g., by controlling hydration of a hydrocolloid), promote solubility of a surfactant, protect against freezing, to improve shelf stability of the concentrate, and to stabilize the resulting foam. Suitable organic solvents include, but are not limited to, polar alkyl ethers including glycols and glycol ethers, such as diethylene glycol monoalkyl ethers, ethylene glycol monoalkyl ether, propylene glycol monoalkyl ethers, dipropylene glycol monoalkyl ethers such as diethylene glycol n-butyl ether, dipropylene glycol n-propyl ether, hexylene glycol, ethylene glycol, dipropylene glycol monobutyl ether, dipropylene glycol monomethyl ether, dipropylene glycol monopropyl ether, propylene glycol, glycerol, polyethylene glycol (PEG) and sorbitol, 1-butoxyethoxy-2-propanol, and higher alkyl glycols, such as hexylene glycol, glycerine, and the like as described in various US patents, including U.S. Pat. Nos. 3,579,446, 3,422,011, 3,457,172, and 5,616,273, the disclosures of which are incorporated herein by reference in their entirety. The solvent component may be present in an amount of from 30 to 99 wt. %, from 40 to 95 wt. %, from 50 to 90 wt. %, from 55 to 85 wt. %, or from 60 to 80 wt. % based on a total weight of the foam forming concentrate.

In certain embodiments, the solvent component includes a polar alkyl ether. It is contemplated herein that the polar alkyl ether promotes self-healing of the continuous foam layer formed from the foam forming concentrate. Furthermore, it is believed that the polar alkyl ether may be utilized in the foam forming concentrate to control hydration of the gelling component by forming partially hydrated carbohydrates or synthetic hydrocolloids. The partially hydrated carbohydrates or synthetic hydrocolloids provide a balance between forming the foam and maintaining dispersibility of the foam thereby promoting self-healing of the continuous foam layer. In particular, it is contemplated herein that the gelling component and the polar alkyl ether may cooperate to provide partial hydration of the gelling component during formation of the foam forming concentrate. Without being bound by theory, it is believed that organic solvent to water ratio of the foam forming concentrate provides a solvent-rich concentrate suitable for managing free water content thereby limiting hydration of the gelling component to only partial hydration. Dilution of the foam foaming concentrate with an abundance of free water allows full hydration of the gelling component inclusive to form the foam solution. It is contemplated that an increase in free water concentration (e.g., after combination with water prior to application) provides substantially full hydration of the gelling component. Substantially full hydration of the gelling component provides improved foam formation, extend drain time, self-healing, and fire extinguishment.

In certain embodiments, the polar alkyl ether is selected from the group of diethylene glycol monobutyl ether, ethylene glycol mono-n-butyl ether, ethylene glycol mono-n-propyl ether, triethylene glycol ethyl ether, triethylene glycol mono n-butyl ether, tripropylene glycol methyl ether, propylene glycol mono n-propyl ether, or combinations thereof. In these and other embodiments, the polar alkyl ether includes diethylene glycol monobutyl ether and ethylene glycol mono-n-butyl ether. The polar alkyl ether may be present in an amount of at least 1 wt. %, at least 5 wt. %, at least 10 wt. %, at least 12.5 wt. %, or at least 15 wt. % based on a total weight of the solvent component. The polar alkyl ether may be present in an amount of no greater than 99 wt. %, no greater than 60 wt. %, no greater than 50 wt. %, no greater than 40 wt. %, or no greater than 30 wt. % based on a total weight of the solvent component. The polar alkyl ether may be present in an amount of from 1 to 99 wt. %, from 5 to 60 wt. %, from 10 to 50 wt. %, from 12.5 to 40 wt. %, or from 15 to 30 wt. % based on a total weight of the solvent component. It is to be appreciated that the amount of the polar alkyl ether utilized may be dependent on the hydration of the gelling component, which can be impacted by amount, pH, salt content, functionality of the gelling component, and the like.

In various embodiment, in addition to the polar alkyl ether, the solvent component further includes an alkylene glycol and water. In certain embodiments, the alkylene glycol includes ethylene glycol, propylene glycol, butylene glycol, or combinations thereof. In exemplary embodiments, the solvent component includes propylene glycol. The alkylene glycol may be present in an amount of at least 1 wt. %, at least 5 wt. %, at least 10 wt. %, at least 12.5 wt. %, or at least 15 wt. % based on a total weight of the solvent component. The alkylene glycol may be present in an amount of no greater than 99 wt. %, no greater than 60 wt. %, no greater than 50 wt. %, no greater than 40 wt. %, or no greater than 30 wt. % based on a total weight of the solvent component. The alkylene glycol may be present in an amount of from 1 to 99 wt. %, from 5 to 60 wt. %, from 10 to 50 wt. %, from 12.5 to 40 wt. %, or from 15 to 30 wt. % based on a total weight of the solvent component.

The water may be present in an amount of at least 1 wt. %, at least 10 wt. %, at least 20 wt. %, at least 40 wt. %, or at least 50 wt. % based on a total weight of the solvent component. The water may be present in an amount of no greater than 99 wt. %, no greater than 95 wt. %, no greater than 85 wt. %, no greater than 75 wt. %, or no greater than 65 wt. % based on a total weight of the solvent component. The water may be present in an amount of from 1 to 99 wt. %, from 10 to 95 wt. %, from 20 to 85 wt. %, from 40 to 75 wt. %, or from 50 to 65 wt. % based on a total weight of the solvent component.

The foam forming concentrate may further include a plurality of micron-sized particles or nanoparticles. The plurality of particles can provide the foam forming concentrate with improved shelf stability. It is contemplated that the plurality of particles may cooperate with the solvent component to limit full hydration of the gelling component and to suspend the gelling component in the foam forming concentrate prior to dilution of the foam forming concentrate with water. Non-limiting examples of suitable particles include, treated or untreated, fumed silica, zeolite, clays (e.g., bentonite and lamponite), silicon, alumina, magnesium oxide, quartz, graphite, silicon carbide, nanoparticles, and the like. In view of the contemplated interaction with the solvent component and where the particles are treated, it is especially contemplated that the treatment will introduce hydrophobicity to the particles (e.g., via silylation with hydrophobic silane such as dimethyldichlorosilane) to thereby limit or even prevent hydration of the gelling component in the concentrate. Such reduction has unexpectedly been shown to increase stability and shelf life of the concentrates. The plurality of particles may be present in an amount of at least 0.01 wt. %, at least 0.05 wt. %, at least 0.07 wt. %, at least 0.09 wt. %, or at least 0.1 wt. % based on a total weight of the foam forming concentrate. The plurality of particles may be present in an amount of no greater than 5 wt. %, no greater than 2 wt. %, no greater than 1 wt. %, no greater than 0.5 wt. %, or no greater than 0.2 wt. % based on a total weight of the foam forming concentrate. The plurality of particles may be present in an amount of from 0.01 to 5 wt. %, from 0.05 to 2 wt. %, from 0.07 to 1 wt. %, from 0.09 to 0.5 wt. %, or from 0.1 to 0.2 wt. % based on a total weight of the foam forming concentrate.

The foam forming concentrate may various additives, such as fillers (e.g., urea, citric acid, alkanolamine), sequestration agents, pH buffers, anticorrosion additives, antimicrobial additives, preservatives, divalent ion salts, foam stabilizers, humectants, flame retardant materials, and the like as are well-known in the art as described, for example, in “A Firefighter's Guide to Foam”, published by National Foam, Inc. or in BS EN 13565-1 and BS EN 13565-2, or in NFPA Standards, the disclosure of each of which is incorporated herein by reference in its entirety.

The foam forming concentrate can be prepared by mixing or combining together its ingredients (e.g., the solvent component, the surfactant component, the hydrocolloid component, along with any additionally desired ingredients). For example, a foam forming concentrate can be prepared by providing the solvent components, such as a fixed amount within a reaction vessel or other container, or a flow of the solvent component traveling through a hose or pipe, and then adding the other ingredients (e.g., surfactant component, hydrocolloid component, etc.) to the solvent component. The other ingredients can be added to the solvent component individually or as one or more mixtures, and in any desired order. Further, portions of the solvent component may be added individually or as one or more mixtures in any desired order.

The foam forming concentrate can be utilized by applying the foam forming concentrate to foam production equipment known in the fire-fighting art. Such equipment can include a conventional hose to carry a flow of water, plus appurtenant equipment useful to inject, educt or otherwise add the foam forming concentrate to the flow of water. Water can flow under pressure through a fire hose, and the foam forming concentrate can be injected or drawn (e.g., by venturi effect) into the flow of water. Other techniques such as compressed gas foaming systems can be employed as well known to those skilled in the art. The application of the foam forming concentrate to the water of the equipment may be configured to dilute the foam forming concentrate to a desired amount (e.g., at least 0.1% w/w, at least 1% w/w, at least 2% w/w, at least 3% w/w, at least 4% w/w, at least 5% w/w, at least 6% w/w, or even more) to form the foam solution. The foam solution may have a viscosity of no greater than 100 centipoise, no greater than 55 centipoise, or even less. Furthermore, fire extinguisher canisters may include the foam forming concentrate or the foam forming solution.

In another aspect of the invention, the inventors contemplate that the foam includes, or is formed from, the foam forming concentrate and water (e.g., fresh water, salt water, brackish water, etc.). As described above, the foam forming concentrate may be diluted with water (e.g., to a concentration of from 0.1 wt. % to 6 wt. % or even more) to form the foam solution. The foam solution may be applied to a fuel, such as heptane, that is on fire to form the foam over the fuel thereby extinguishing the fire. The foam may extend in a continuous layer to a periphery over the fuel. In various embodiments, an external force is applied to the continuous layer to form a disruption in the continuous layer. In these and other embodiments, the disruption may be formed by introducing a pole approximately 1 inch in diameter with continuous stirring to the foam to open the continuous layer of the foam and expose the fuel. The fuel is ignited behind the pole and burns as it is stirred. The foam is capable of “self-healing” to extinguish the fire formed from ignition of the exposed fuel. Self-healing describes the foam's ability to close in on itself, and reform over the exposed fuel to extinguish the fire. In certain embodiments, continuous stirring is performed for a time period of from 10 to 30 seconds in a “figure 8” pattern.

The foam solution including the foam forming concentrate in amount of 1 wt. % based on a total weight of the foam solution is capable of extinguishing a fire fueled by heptane within a time period of less than 5 minutes when applied at a rate of 3 gallons per minutes as determined in accordance with UL 162 (Class B). Likewise, the foam solution including the foam forming concentrate in amount of 0.1 wt. % based on a total weight of the foam solution is capable of extinguishing a fire fueled by 3-A wood crib including 18 layers of 8 wood members with each member having the dimensions of 38 mm by 38 mm by 735 mm and heptane within a time period of less than 1 minute when applied in an amount of 2.5 gallons as determined in accordance with NFPA 18 (Class A). However, it is to be appreciated that the foam solution including the foam forming concentrate can be utilized to extinguish fire fueled by a variety of flammable liquids. It also to be appreciated that the foam solution may be able to meet or exceed other extinguishment standards, such as applying the foam solution at a rate of 2 gallon per minute with extinguishment in less than 3 minutes.

The foam forming concentrate is employed to combat fires of flammable liquids. The foam forming concentrate is suitable for application as a foam solution to form a foam. As described above, the foam forming concentrate is stored in the form of an aqueous concentrate only requiring dilution typically as a 0.1, 1, 3, 6% or even more to form the foam solution with either fresh, brackish or sea water to form the “premix”, followed by aeration of the premix to produce a foam which is applied to the burning substrate.

### Examples

The following examples are included to demonstrate various embodiments as contemplated herein. It should be appreciated by those of skill in the art that the techniques disclosed in the examples which follow represent techniques discovered by the inventor(s) to function well in the practice of the invention, and thus can be considered to constitute desirable modes for its practice. However, those of skill in the art should, in light of the present disclosure, appreciate that many changes can be made in the specific embodiments which are disclosed and still obtain a like or similar result without departing from the spirit and scope of the invention. All percentages are in wt. % and all measurements are conducted at 23° C. unless indicated otherwise.

### Exemplary and Prophetic Formulations of the Foam Forming Concentrates

Exemplary formulations (Ex. I and Ex. II) of the foam forming concentrate were formed and evaluated for fire extinguishment in accordance with UL 162. The exemplary formulations were prepared using a batch process while maintaining the temperature of the formulations below 40° C. Prophetic formulations (Pr. I, Pr. II, Pr. III, and Pr. IV) of the foam forming concentrate are contemplated. Provided below are exemplary and prophetic formulations of the foam forming concentrates.

TABLE I
Formulations

| | Ex. I | Ex. II | Pr. I | Pr. II | Pr. II | Pr. IV |
|---|---|---|---|---|---|---|
| Ingredient | (wt. %) | (wt. %) | (wt. %) | (wt. %) | (wt. %) | (wt. %) |
| Anionic | 9.84 | 12.12 | 9.84 | 12.12 | 14 | 14 |
| Surfactant I | | | | | | |
| Anionic | 1.30 | 1.28 | 1.30 | 1.28 | | |
| Surfactant II | | | | | | |
| Amphoteric | 3.81 | 3.76 | 3.81 | 3.76 | 10 | 10 |
| Surfactant I | | | | | | |
| Nonionic | 1.56 | 1.54 | 1.56 | 1.54 | 6 | 6 |
| Surfactant I | | | | | | |
| Nonionic | 1.25 | — | 1.25 | — | | |
| Surfactant II | | | | | | |
| Polysaccharide | 6.07 | 5.99 | — | — | 15 | — |
| I | | | | | | |
| Polysaccharide | — | — | 6.07 | 5.99 | — | 15 |
| II | | | | | | |
| Polar Alkyl | 7.41 | 7.32 | 7.41 | 7.32 | 7.32 | 7.32 |
| Ether I | | | | | | |
| Polar Alkyl | 8.92 | 8.80 | 8.92 | 8.80 | 8.80 | 8.80 |
| Ether II | | | | | | |
| Alkylene | 22.22 | 22.06 | 22.22 | 22.06 | 22.06 | 22.06 |
| Glycol I | | | | | | |
| Filler I | 1.54 | 1.52 | 1.54 | 1.52 | 1.52 | 1.52 |
| Filler II | 1.02 | 1.00 | 1.02 | 1.00 | 1.00 | 1.00 |
| Filler III | 1.61 | 1.59 | 1.61 | 1.59 | 1.59 | 1.59 |
| Water | 33.45 | 33.02 | 33.45 | 33.02 | 12.71 | 12.71 |
| TOTAL | 100 | 100 | 100 | 100 | 100 | 100 |

Anionic Surfactant I is ammonium lauryl sulfate which is commercially available.

Anionic Surfactant II is sodium lauryl sulfate which is commercially available.

Amphoteric Surfactant I is cocoamidopropyl betaine which is commercially available.

Nonionic Surfactant I is an alkyl polyglucoside which is commercially available.

Nonionic Surfactant II is an alkoxylated polyol which is commercially available.

Polysaccharide I is a polysaccharide which is commercially available.

Polysaccharide II is a modified starch which is commercially available.

Polar Alkyl Ether I is diethylene glycol monobutyl ether which is commercially available.

Polar Alkyl Ether II is ethylene glycol mono-n-butyl ether which is commercially available.

Alkylene Glycol I is propylene glycol which is commercially available.

Filler I is urea which is commercially available.

Filler II is citric acid which is commercially available.

Filler III is 2-amino-2-methyl-1-propanol which is commercially available.

### Evaluation of the Exemplary Formulations (Class B)

The formulations were then evaluated for extinguishment performance by preparing a 50 sq. ft. pan including heptane that is burning. Each formulation was diluted to 3% (w/w) in water and directly applied to the burning heptane at a rate of 3 gallons per minute in a Type III direct application. Provided below are evaluations of the exemplary formulation of the foam forming concentrates in accordance with UL 162 (Class B).

TABLE II
Evaluation of the Formulations

| | | | | Time from | Time from |
|---|---|---|---|---|---|
| | | | | application | application |
| | | Fuel temp | Ambient | start | start |
| | Conc. | (F.) | temp (F.) | to control | to extinguish |
| Ex. I | 3.0% | 79.2 | 61.0 | 1:13 | 2:10 |
| Ex. II | 3.0% | 77.1 | 61.0 | 1:13 | 1:52 |

### Expected Evaluation of the Prophetic Formulations (Class B)

The contemplated formulations are expected to be evaluated for extinguishment performance by preparing a 50 sq. ft. pan including heptane that is burning. Each formulation will be diluted to 3% (w/w) in water and directly applied to the burning heptane at a rate of 3 gallons per minute in a Type III direct application. Provided below are expected evaluations of the prophetic formulation of the foam forming concentrates in accordance with UL 162 (Class B).

TABLE III
Evaluation of the Formulations

| | | | | Time from | Time from |
|---|---|---|---|---|---|
| | | | | application | application |
| | | | Ambient | start to | start to |
| | | Fuel temp | temp | control | extinguish |
| | Conc. | (° F.) | (° F.) | (min.) | (min.) |
| Pr. I | 3.0% | >75 and <85 | >55 and <65 | <2 | <3 |
| Pr. II | 3.0% | >75 and <85 | >55 and <65 | <2 | <3 |
| Pr. III | 1.0% | >75 and <85 | >55 and <65 | <2 | <3 |
| Pr. IV | 1.0% | >75 and <85 | >55 and <65 | <2 | <3 |

In some embodiments, the numbers expressing quantities of ingredients, properties such as concentration, reaction conditions, and so forth, used to describe and claim certain embodiments of the invention are to be understood as being modified in some instances by the term “about.” Accordingly, in some embodiments, the numerical parameters set forth in the written description and attached claims are approximations that can vary depending upon the desired properties sought to be obtained by a particular embodiment. The recitation of ranges of values herein is merely intended to serve as a shorthand method of referring individually to each separate value falling within the range. Unless otherwise indicated herein, each individual value is incorporated into the specification as if it were individually recited herein.

All methods described herein can be performed in any suitable order unless otherwise indicated herein or otherwise clearly contradicted by context. The use of any and all examples, or exemplary language (e.g., “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise. As also used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously.

It should be apparent to those skilled in the art that many more modifications besides those already described are possible without departing from the inventive concepts herein. The inventive subject matter, therefore, is not to be restricted except in the scope of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification or claims refer to at least one of something selected from the group consisting of A, B, C . . . and N, the text should be interpreted as requiring only one element from the group, not A plus N, or B plus N, etc.

1. A foam forming concentrate comprising:
a surfactant component comprising an anionic surfactant and an amphoteric surfactant, the surfactant component present in an amount of at least 5 wt. % based on a total weight of the foam forming concentrate;
a solvent component comprising a polar alkyl ether and water; and
a gelling component selected from the group of a carbohydrate, a synthetic hydrocolloid, or a combination thereof, the gelling component present in an amount of at least 0.1 wt. % based on a total weight of the foam forming concentrate, wherein the gelling component is substantially insoluble in the solvent component;
wherein the foam forming concentrate has a viscosity of no greater than 2,000 centipoise; and
wherein the foam forming concentrate at a concentration of at least 1% (w/w) in water is capable of extinguishing a fire fueled by heptane within a time period of less than 5 minutes at a flow rate of 3 gallons per minute as determined in accordance with UL 162.

2. The foam forming concentrate of claim 1, wherein the anionic surfactant is selected from the group of an ammonium alkyl sulfate, a sodium alkyl sulfate, alkyl diphenyloxide disulfonate, a carboxylic acid surfactant, dioctyl sulfosuccinate, or combinations thereof.

3. The foam forming concentrate of claim 2, wherein the anionic surfactant comprises ammonium alkyl sulfate and a sodium alkyl sulfate.

4. The foam forming concentrate of claim 3, wherein the ammonium alkyl sulfate comprises ammonium lauryl sulfate.

5. The foam forming concentrate of claim 3, wherein the sodium alkyl sulfate comprises sodium lauryl sulfate.

6. The foam forming concentrate of claim 1, wherein the amphoteric surfactant is selected from the group of a betaine, alkyl hydroxysultaine, alkyl amine oxide, alkyl aminopropionic acid, or combinations thereof.

7. The foam forming concentrate of claim 6, wherein the betaine comprises an alkyl amido betaine.

8. The foam forming concentrate of claim 7, wherein the alkyl amido betaine comprises cocoamidopropyl betaine.

9. The foam forming concentrate of claim 1, wherein the surfactant component further comprises a nonionic surfactant.

10. The foam forming concentrate of claim 9, wherein the nonionic surfactant is selected from the group of an alkyl polyglucoside, a silicon-based surfactant, a branched secondary alcohol ethoxylates, alkoxylated polyol, a block copolymer of two or more of polyoxyethylene, polyoxypropylene and polyoxybutylene, or a combination thereof.

11. The foam forming concentrate of claim 10, wherein the nonionic surfactant comprises an alkyl polyglucoside.

12. The foam forming concentrate of claim 1, wherein the carbohydrate comprises a polysaccharide.

13. The foam forming concentrate of claim 12, wherein the polysaccharide is selected from the group of a modified starch, agar, sodium alginate, carrageenan, gum guaicum, neem gum, Pistacia lentiscus, gum chatti, caranna, galactomannan, gum tragacanth, karaya gum, guar gum, welan gum, rhamsam gum, locust bean gum, beta-glucan, cellulose, methylcellulose, chicle gum, kino gum, dammar gum, gum arabic, glucomannan, mastic gum, spruce gum, tara gum, pysllium seed husks, gellan gum, xanthan gum, acacia gum, cassia gum, diutan gum, fenugreek gum, ghatti gum, hydroxyethylcellulose, hydroxypropylmethylcellulose, karaya gum, konjac gum, pectin, propylene glycol alginate, or combinations thereof.

14. The foam forming concentrate of claim 1, wherein the polar alkyl ether is selected from the group of diethylene glycol monobutyl ether, ethylene glycol mono-n-butyl ether, ethylene glycol mono-n-propyl ether, triethylene glycol ethyl ether, triethylene glycol mono n-butyl ether, tripropylene glycol methyl ether, propylene glycol mono n-propyl ether, or combinations thereof.

15. The foam forming concentrate of claim 14, wherein the polar alkyl ether comprises diethylene glycol monobutyl ether and ethylene glycol mono-n-butyl ether.

16. The foam forming concentrate of claim 1, wherein the solvent component further comprises an alkylene glycol, water, or a combination thereof.

17. The foam forming concentrate of claim 16, wherein the alkylene glycol comprises propylene glycol.

18. The foam forming concentrate of claim 1, wherein the foam forming concentrate at a concentration in water of at least 3% (w/w) is capable of extinguishing a fire fueled by heptane within a time period of less than 3 minutes as determined in accordance with UL 162.

19. The foam forming concentrate of claim 1, wherein the water utilized to dilute the foam forming concentrate is selected from the group of fresh water, salt water, brackish water, or combinations thereof.

20. A foam solution comprising the foam forming concentrate of claim 1 and water, wherein the foam solution forms a foam that extends in a continuous layer to a periphery.

21. The foam solution of claim 20, wherein the foam is capable of reforming the continuous layer after an external force is applied to the continuous layer to form a disruption in the continuous layer.

22. The foam solution of claim 20, wherein the foam solution comprising the foam forming concentrate in amount of 3 wt. % based on a total weight of the foam is capable of extinguishing a fire fueled by heptane within a time period of less than 3 minutes at a flow rate of 3 gallons per minutes as determined in accordance with UL 162.

23. The foam solution of claim 20, wherein the water is selected from the group of fresh water, salt water, brackish water, or combinations thereof.

24. The foam solution of claim 20, wherein the foam solution has a viscosity of no greater than 200 centipoise.

25. The foam solution of claim 24, wherein the foam solution has a viscosity of no greater than 150 centipoise.

26. A foam forming concentrate comprising:
a surfactant component comprising an anionic surfactant and an amphoteric surfactant, the surfactant component present in an amount of at least 5 wt. % based on a total weight of the foam forming concentrate;
a solvent component comprising a polar alkyl ether and water; and
a carbohydrate present in an amount of at least 0.1 wt. % based on a total weight of the foam forming concentrate, wherein the carbohydrate is substantially insoluble in the solvent component;
wherein the foam forming composition has a viscosity of no greater than 2,000 centipoise; and
wherein the foam forming concentrate at a concentration of at least 1% (w/w) in water is capable of extinguishing a fire fueled by heptane within a time period of less than 5 minutes at a flow rate of 3 gallons per minute as determined in accordance with UL 162.

27. A foam forming concentrate comprising:
a surfactant component comprising an anionic surfactant and an amphoteric surfactant, the surfactant component present in an amount of at least 5 wt. % based on a total weight of the foam forming concentrate;
a solvent component comprising a polar alkyl ether and water; and
a synthetic hydrocolloid present in an amount of at least 0.1 wt. % based on a total weight of the foam forming concentrate, wherein the synthetic hydrocolloid is substantially insoluble in the solvent component;
wherein the foam forming concentrate has a viscosity of no greater than 2,000 centipoise; and
wherein the foam forming concentrate at a concentration of at least 1% (w/w) in water is capable of extinguishing a fire fueled by heptane within a time period of less than 5 minutes at a flow rate of 3 gallons per minute as determined in accordance with UL 162.
